(19) United States
(12) Patent Application Publication
(10) Pub. No.: US 2008/0092856 A1
(43) Pub. Date: Apr. 24, 2008

(54) Piston arrangement for engine

(76) Inventor: Arthur Banks Williamson, Riverdale, GA (US)

Correspondence Address: WITHERS & KEYS, LLC, P. O. BOX 2049, MCDONOUGH, GA, 30253, US

(21) Appl. No.: 11/511,993

(22) Filed: Aug. 29, 2006

(51) Int. Cl. F02B 75/04

(52) U.S. Cl. 123/48 R

(57) ABSTRACT

Piston arrangements for engines are disclosed. The disclosed piston arrangements include at least one stationary member and two or more movable members.

### TECHNICAL FIELD

Piston arrangements for engines are disclosed.

### BACKGROUND

In engine or motor design, one or more pistons are utilized to convert chemical energy contained in various fuels into linear motion of the pistons and then to convert the linear motion of the pistons into rotational motion in order to rotate a crank shaft. Conventional piston systems typically comprise one or more pistons, wherein each piston comprises a single movable member (i.e., the piston) in the form of a cylindrical member, and a single stationary component in the form of a wall or housing that surrounds the single movable member (i.e., the piston). As each piston moves up and down in a linear motion, the piston motion causes the crank shaft to rotate. In order to convert the linear motion of the pistons to rotational motion, linkages connect the pistons to the crank shaft.

There are several different stages that a conventional piston goes through in order to produce power: fuel intake into a cylindrical cavity, compression of the fuel in the cylindrical cavity by movement of the piston within the cylindrical cavity so as to decrease the fuel-occupied volume of the cavity, combustion of the fuel where the fuel is ignited in the cylindrical cavity resulting in expansion of the fuel-occupied volume of the cavity, and exhaust of the spent fuel out of the cylindrical cavity by again decreasing the size of the cylindrical cavity via piston linear motion. Typically these various stages are referred to as an “intake stroke,” a “compression stroke,” a “power” or “combustion stroke”, and an “exhaust stroke.”

The power-producing part of a conventional engine's operating cycle starts with the compression stroke. Following compression, ignition of the fuel then releases the fuel's chemical energy and produces high-temperature, high-pressure combustion products. These gases then expand within each cavity causing the size of the cavity to increase and transfer work to the piston. Thus, as the engine is operated continuously, mechanical power is produced.

The type of engine or motor is often referred to as either a “two-cycle” or “four-cycle” engine based on the number of linear, directional changes that a piston makes during a given cycle. There are two commonly used internal combustion engine cycles: the two-stroke cycle and the four-stroke cycle.

The fundamental difference between two-cycle engines and four-cycle engines is in their gas exchange process, or more simply, the removal of the burned gases at the end of each expansion process and the induction of a fresh mixture for the next cycle. The two-cycle engine has an expansion, or power stroke, in each cavity during each revolution of the crankshaft.

In a four-cycle engine, the burned gasses are first displaced by the piston, and then a fresh charge of fuel enters the cavity during the following stroke. This means that four-cycle engines require two complete turns of the crankshaft to make a power stroke, versus the single turn necessary in a two-cycle engine. In other words, two-cycle engines operate on 360 degrees of crankshaft rotation, whereas four-cycle engines operate on 720 degrees of crankshaft rotation.

In known piston arrangements, cylindrical pistons are used such that the cavity size is the same for both the intake of fuel and the combustion of fuel. This arrangement is inefficient in that the size of cavity necessary for fuel intake is often different and independent of that for combustion.

### SUMMARY

The present invention addresses the need for new piston arrangements. Features of some embodiments provide for a piston arrangement with at least one stationary member and two or more moving members so that a size of a cavity bounded by the various members, and, in turn, an internal volume proportional to the cavity, is varied by moving the various movable members with respect to the stationary member. Further, because of the geometry of the piston arrangements, the size of the cavity can be different for both intake of fuel and combustion.

In one exemplary embodiment, the piston arrangement comprises at least one stationary member; first and second movable members; and a fuel-ignition cavity formed between one or more outer surfaces of the at least one stationary member and one or more outer surfaces of each of the first and second movable members; wherein a size of the fuel-ignition cavity changes as the first and second movable members move along outer surfaces of the at least one stationary member.

The present invention is also directed to an internal combustion engine comprising the above-described piston arrangement. In one exemplary embodiment, the internal combustion engine comprises a crankshaft housing; a crankshaft located within the crankshaft housing; a piston arrangement comprising at least one stationary member, first and second movable members, opposing first and second plates positioned along opposing outer surfaces of the at least one stationary member and the first and second movable members, and a fuel-ignition cavity formed between one or more outer surfaces of the at least one stationary member, one or more outer surfaces of each of the first and second movable members, and opposing outer surfaces of the first and second plates; wherein a size of the fuel-ignition cavity changes as the first and second movable members move along outer surfaces of the at least one stationary member between the opposing outer surfaces of the first and second plates; and wherein the crankshaft is linked to the first movable member such that as the first movable member moves along an outer surface of the at least one stationary member, the crankshaft rotates.

The present invention is even further directed to a method of generating power in an internal combustion engine. In one exemplary embodiment, the method of generating power in an internal combustion engine comprises introducing fuel into a fuel-ignition cavity of a piston arrangement, the piston arrangement comprising at least one stationary member, first and second movable members, opposing first and second plates positioned along opposing outer surfaces of the at least one stationary member and the first and second movable members, wherein the fuel-ignition cavity is formed between one or more outer surfaces of the at least one stationary member, one or more outer surfaces of each of the first and second movable members, and opposing outer surfaces of the first and second plates; moving the first and second movable members along outer surfaces of the at least one stationary member between the opposing outer surfaces of the first and second plates so as to compress the fuel; igniting the fuel; allowing the first and second movable members to move along outer surfaces of the at least one stationary member between the opposing outer surfaces of the first and second plates in response to the igniting of the fuel; and linking the first movable member to a crankshaft such that movement of the first movable member along an outer surface of the at least one stationary member causes the crankshaft to rotate so as to generate power.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 is an exploded view of various members of an exemplary piston arrangement of the present invention, wherein the various members are separated from one another;

FIG. 2 is an exploded view of the exemplary piston arrangement of FIG. 1 when the movable members are in a first position during actual operation;

FIG. 3 is an exploded view of the exemplary piston arrangement of FIGS. 1-2 when the movable members are in a second position during actual operation;

FIG. 4 is an exploded view of the exemplary piston arrangement of FIGS. 1-3 when the movable members are in a third position during actual operation;

FIG. 5 is an exploded view of the exemplary piston arrangement of FIGS. 1-4 when the movable members are in a fourth position during actual operation;

FIG. 6 is an enlarged exploded view of the exemplary piston arrangement of FIGS. 1-5 further illustrating bottom and top plates;

FIG. 7 is an exploded view of another exemplary piston arrangement when the movable members are in a first position during actual operation;

FIG. 8 is a cross-sectional view of the exemplary piston arrangement of FIG. 7 when the movable members are in a second position during actual operation;

FIG. 9 is a cross-sectional view of the exemplary piston arrangement of FIGS. 7-8 when the movable members are in a third position during actual operation; and

FIG. 10 is a cross-sectional view of the exemplary piston arrangement of FIGS. 7-9 when the movable members are in a fourth position during actual operation.

### DETAILED DESCRIPTION

The present invention is directed to various piston arrangements for use in combustion engines. The present invention is further directed to an internal combustion engine comprising one of the disclosed piston arrangements. Piston arrangements of the present invention comprise a number of stationary and moving members as described below with reference to the figures.

### I. Exemplary Three Member Piston Arrangement

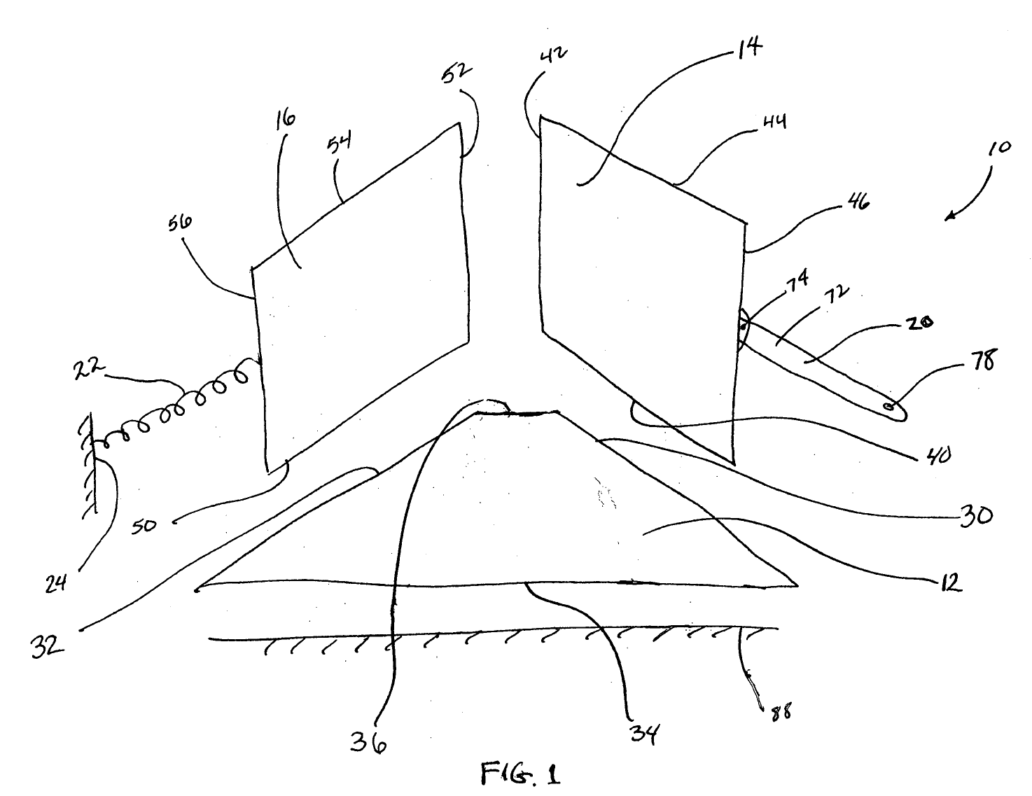

In one exemplary embodiment, the piston arrangement of the present invention comprises three members: one stationary member and two movable members positioned between opposing plates. FIGS. 1-5 show various views of this exemplary embodiment.

A. Three Member Piston Arrangement Components

As shown in FIGS. 1-5, exemplary piston arrangement 10 comprises stationary member 12 and two movable members 14 and 16 which move relative to stationary member 12. As illustrated in exemplary piston arrangement 10 of FIG. 1, stationary member 12 may have a first surface or side 30, a second side 32, a third side 34, and a fourth side 36. First movable member 14 may have a first side 40 that contacts first side 30 of stationary member 12, second side 42, third side 44 and fourth side 46. Second movable member 16 may have a first side 50 that contacts second side 32 of stationary member 12, second side 52 that contacts second side 42 of first movable member 14, third side 54, and fourth side 56. Note that although stationary member 12 and first and second moving members 14 and 16 are each illustrated with four sides, the various members may have any suitable shape, any suitable number of sides and such sides may be planar or of other various shapes including conical, spherical, curved, etc. Typically, each side has a planar surface having a square, rectangular, or polygonal shape.

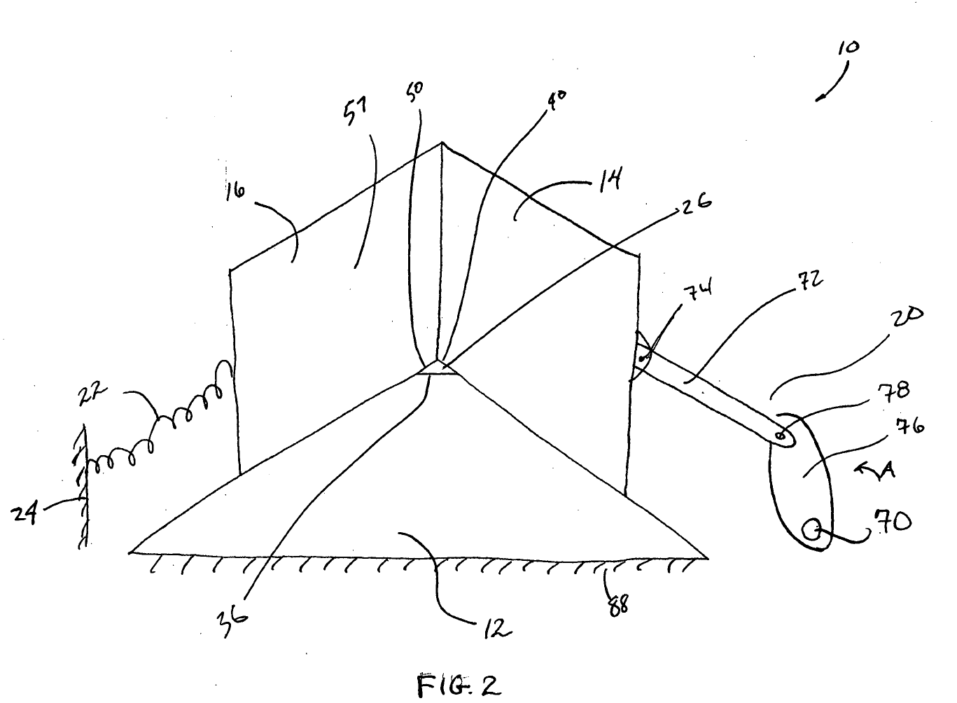

As shown in FIG. 2, at least a portion of first movable member 14 (e.g., first side 40) is in constant contact with at least a portion of stationary member 12 (e.g., first side 30). Such sides or surfaces 30 and 40 may be held in contact with each other through various means as known in the art such as by rails, springs, member configuration relative to other members and opposing plates (not shown), etc. Similarly, at least a portion of second movable member 16 (e.g., first side 50) is in constant contact with at least a portion of stationary member 12 (e.g., second side 32). In addition, at least a portion of first movable member 14 (e.g., second side 42) is in constant contact with at least a portion of second movable member 16 (e.g., second side 52).

As shown in FIG. 2, a linkage 20 connects first movable member 14 to a crankshaft 70 such that when first movable member 14 moves, crankshaft 70 rotates. Linkage 20 comprises a first arm 72 and a second arm 76. First arm 72 is pivotally connected to first movable member 14 by way of pin 74 at one end and pivotally connected to second arm 76 at the other end by pin 78. Second arm 76 is connects to first arm 72 at one end and to crankshaft 70 at the other end.

FIGS. 1-5 also illustrate a biaser 22, which may be supported by a wall 24 so as to force second side 52 of second movable member 16 into contact with at least a portion of second side of first movable member 14. Biaser 22 may be any biasing member including, but not limited to, a spring, a hydraulic member, and a pneumatic member. Note that although biaser 22 is shown in FIG. 1 as being connected to fourth side 56 of second movable member 16, biaser 22 could be attached to another side of second movable member 16 or one of major surfaces 57 or 58 of second movable member 16. Biaser 22 may cooperate with a set of interlocking channels (not shown) along first movable member 14 (e.g., first side 40 and/or second side 42) and second movable member 16 (e.g., first side 50 and/or second side 52) such that first and second movable members 14 and 16 are in constant slidable contact along a restricted path.

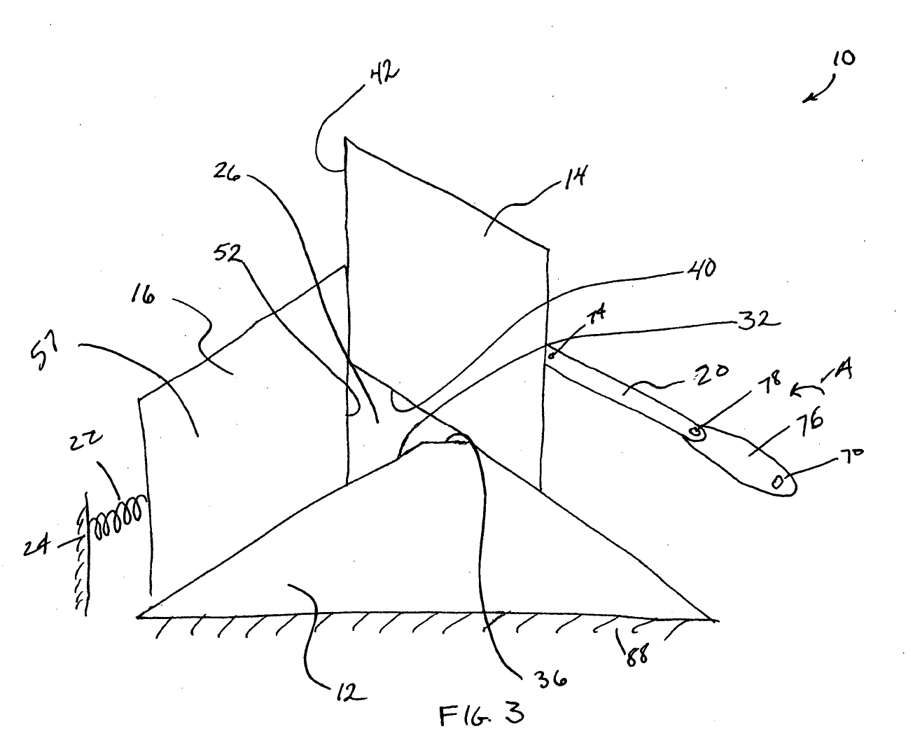

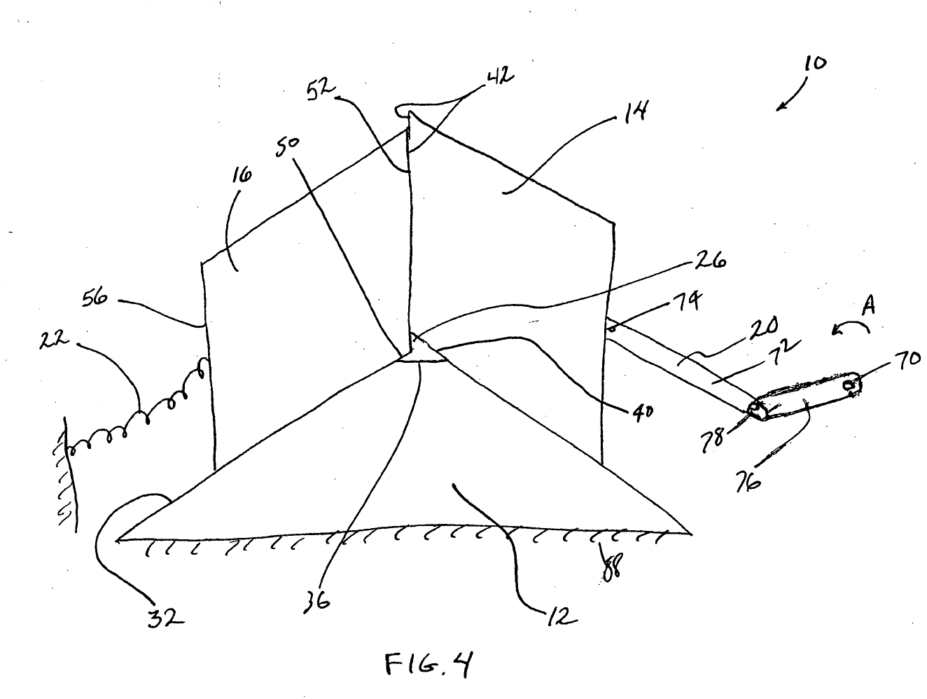

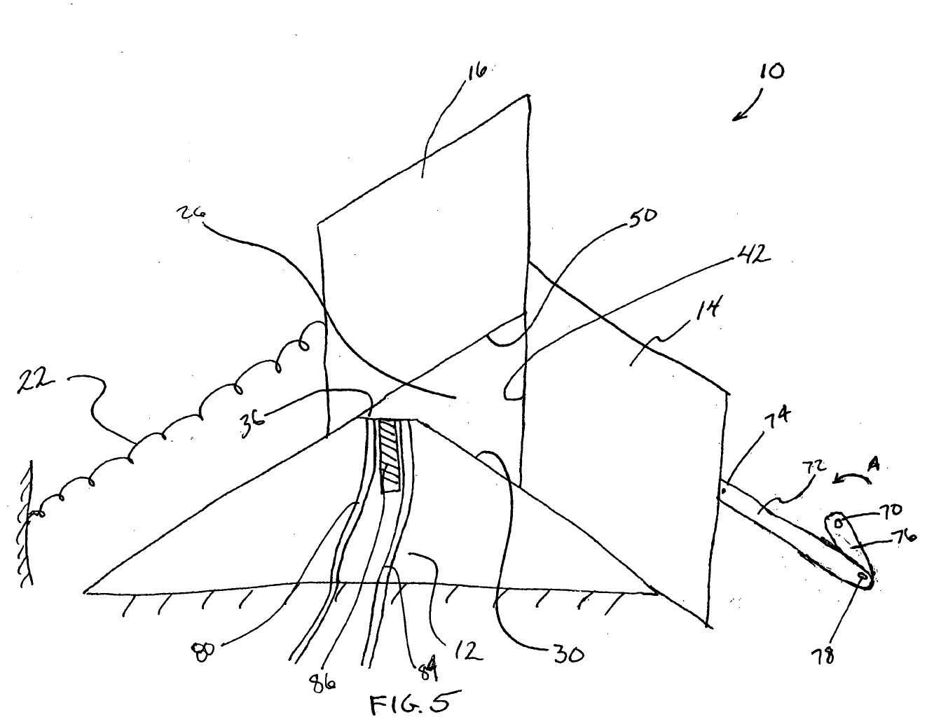

As shown in FIGS. 2-5, a cavity 26 is bounded by stationary member 12 and first and second movable members 14 and 16, and changes shape as the members move from one position to another. In the configuration shown in FIG. 2, cavity 26 is bounded by (i) fourth side 36 of stationary member 12, (ii) first side 40 of first movable members 14, and first side 50 of second movable member 16. In the configuration shown in FIG. 3, cavity 26 is bounded by (i) fourth side 36 of stationary member 12, (ii) second side 32 of stationary member 12, (iii) second side 52 of second movable member 16, and (iv) first side 40 of first movable members 14. In the configuration shown in FIG. 4, cavity 26 is bounded by (i) fourth side 36 of stationary member 12, (ii) first side 50 of second movable member 16, (iii) second side 52 of second movable member 16, and (iv) first side 40 of first movable members 14. In the configuration shown in FIG. 5, cavity 26 is bounded by (i) fourth side 36 of stationary member 12, (ii) first side 50 of second movable member 16, (iii) second side 42 of first movable member 14, and (iv) first side 30 of stationary member 12.

As the size of cavity 26 changes as shown in FIGS. 2-5, displacement of first movable members 14 causes linkage 20 to move in a direction of displacement of first movable member 14, which causes crankshaft 70 to rotate in a direction as illustrated by arrow A.

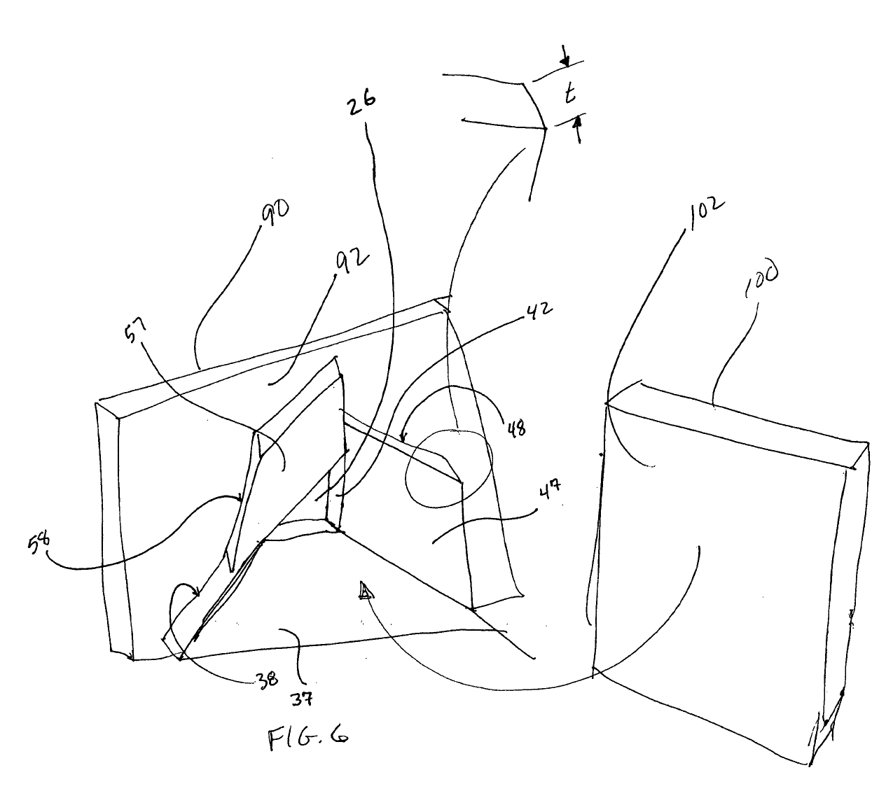

FIG. 5 further illustrates a fuel injector conduit 80, an exhaust remover conduit 84, and a volume adjuster 86. Fuel injector conduit 80 may provide various fuels and/or air into cavity 26. Fuel injector conduit 80 may be ported so as to open at the end of an exhaust stroke and remain open to supply various fuels during an intake stroke. Suitable fuels include, but are not limited to, gasoline, biofuel, alcohol, ethanol, diesel, and other hydrocarbons. In the embodiment illustrated, fuel injector conduit 80 is positioned in stationary member 12; however, it should be noted that fuel injector conduit 80 may be positioned in any suitable location including any of members 12, 14, 16, as well as in a bottom plate 90 or top plate 100 (shown in FIG. 6) in order to provide fuel to cavity 26.

Exhaust remover conduit 84 is utilized to remove exhaust (i.e., combustion by-products) from cavity 26. Like fuel injector conduit 80, exhaust remover conduit 84 may be positioned in any suitable location including any of members 12, 14, 16, as well as in bottom plate 90 or top plate 100 (shown in FIG. 6) in order to remove exhaust from cavity 26.

Volume adjuster 86 may be a piston or similar device, which is adjustable such that the piston (or similar device) may be moved in/out such that the volume of cavity 26 may be varied without changing the configuration of first and second movable members 14 and 16. Volume adjuster 86 is useful in adapting a specific arrangement of stationary and movable members depending on the type of fuel, as well as other engine parameters (e.g., power output, etc.).

FIG. 6 provides a three-dimensional exploded view of some of the above-described components of exemplary piston arrangement 10 of FIGS. 1-5. FIG. 6 further illustrates bottom plate 90 and top plate 100, which are used to sandwich stationary member 12, first movable member 14, and second movable member 16 within a given plane. FIG. 6 shows each of stationary member 12, first movable member 14, and second movable member 16 as three-dimensional objects, such that each respective member has opposite major outer surfaces in addition to the above-described sides (e.g., first side 30, second side 32, third side 34, and fourth side 36 of stationary member 12). For example, stationary member 12 comprises a first major surface 37 and a second major surface 38, while first movable member 14 comprises a first major surface 47 and a second major surface 48, and second movable member 16 comprises a first major surface 57 and a second major surface 58. In addition, exemplary piston arrangement 10 comprises (i) a first plate 100 having a first major surface 102 facing and in contact with first major surface 37 of stationary member 12, first major surface 47 of first movable member 14, and first major surface 57 of second movable member 16, and (ii) a second plate 90 having a first major surface 92 facing and in contact with second major surface 38 of stationary member 12, second major surface 48 of first movable member 14, and second major surface 58 of second movable member 16. For illustrative purposes, exemplary piston arrangement 10 of FIG. 6 shows each of members 12, 14, and 16 being of uniform thickness, t, extending from first major surface 102 of first plate 100 to first major surface 92 of second plate 90.

The volume of cavity 26 is bound by one or more sides of stationary member 12, first movable member 14, and second movable member 16, and major surfaces 102 and 92 of first and second plates 100 respectively. As discussed above, the volume of cavity 26 may be further adjusted via volume adjuster 86 (see FIG. 5) so as to fine tune exemplary piston arrangement 10 for a specific application without the need to change the dimensions of any of members 12, 14 or 16, or thickness t.

B. Strokes of a Three Member Piston Arrangement

FIGS. 2-5 illustrate various configurations of exemplary piston arrangement 10 at various times throughout a given combustion cycle. A description of various strokes within a given cycle is provided below.

1. Intake Stroke

FIG. 2 illustrates a first position in which a size of cavity 26 is minimized. From the configuration shown in FIG. 2, exemplary piston arrangement 10 changes to the configuration shown in FIG. 3 in which first movable member 14 and second movable member 16 are in a second position such that each has been moved toward a left hand side of the illustration. During the change from the configuration of FIG. 2 to the configuration of FIG. 3, fuel may be injected into cavity 26 by exemplary fuel injector 80 (shown in FIG. 5). FIG. 3 illustrates an exemplary maximum intake configuration for cavity 26 based on the positioning of first and second movable members 14 and 16. The transition from the configuration of FIG. 2 to the configuration of FIG. 3 may be termed the “intake stroke.”

2. Compression Stroke

In the transition from the configuration shown in FIG. 3 to the configuration shown in FIG. 4, first and second movable members 14 and 16 of exemplary piston arrangement 10 move into a third position resulting in a reduction in the size of cavity 26, thus compressing the fuel in cavity 26. This transition may be termed the “compression stroke.”

At the end of the compression stroke, the fuel in cavity 26 is ignited. Note that the actual ignition point will depend on numerous factors including, but not limited to, the particular fuel being used, etc. Such an ignition point may be at some point when cavity 26 is of a minimum size (see, for example, FIG. 2) or some point other than when cavity 26 is of a minimum size (e.g., immediately prior to or after reaching a minimum size of cavity 26).

3. Combustion Stroke

As the fuel is combusted in cavity 26, the piston arrangement transitions from the configuration shown in FIG. 4 to the configuration shown in FIG. 5. This transition may be termed the “combustion stroke.”

4. Exhaust Stroke

FIG. 5 is illustrative of exemplary piston arrangement 10 once fuel in cavity 26 has been ignited and burned and is ready to be exhausted from cavity 26. In the transition from the configuration shown in FIG. 5 to the configuration shown in FIG. 2, spent fuel may be exhausted out of cavity 26 by way of exhaust remover 84. This transition may be termed the “exhaust stroke.”

At this point, the complete cycle shown in FIGS. 2-5 may be repeated as desired. In going through the various “strokes,” each movable member changes direction only one time during the four above-described “strokes,” i.e., starting after fuel has been taken into cavity 26 as illustrated by the positions illustrated in FIG. 3, the first and second movable members 14 and 16 (i) each move to the right from the position shown in FIG. 3 to the position shown in FIG. 4 (compression) and continue moving to the right from the position shown in FIG. 4 to the position shown in FIG. 5 (power or combustion), and, then, (ii) each move to the left in transitioning from the position shown in FIG. 5 to the position shown in FIG. 2 (exhaust) and continue moving to the left in transitioning from the position shown in FIG. 2 to the position shown in FIG. 3 (intake). Thus, these four “strokes” are accomplished in only one change of direction of first and second movable members 14 and 16 and result in one revolution of crankshaft 70.

### II. Exemplary Components of a Four Member Arrangement

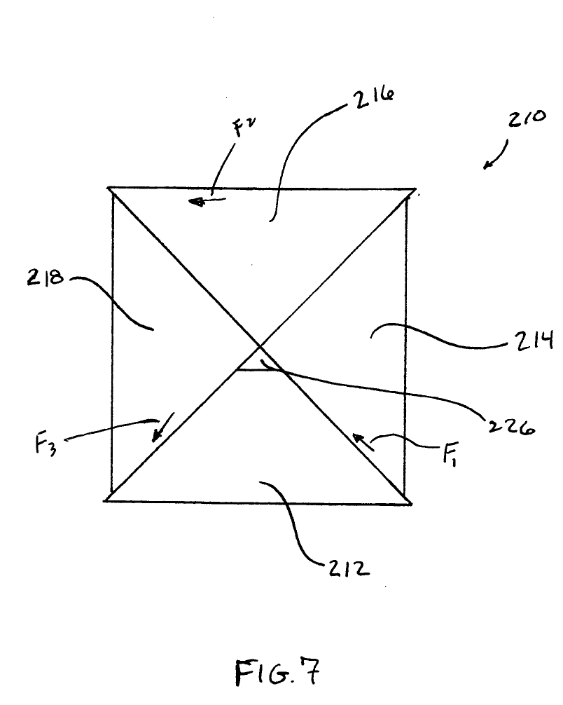

FIGS. 7-10 illustrate another exemplary piston arrangement of the present invention, namely exemplary piston arrangement 210.

A. Four Member Piston Arrangement Components

As shown in FIG. 7, exemplary piston arrangement 210 comprises stationary member 212, first movable member 214, second movable member 216 and a third movable member 218. In this embodiment, cavity 226 is formed between edges of stationary member 212 and first, second and third movable members 214, 216 and 218. Further, in this exemplary embodiment, each of members 212, 214, 216, and 218 may be of uniform thickness t (although thickness t of the various members may be any desired value) such that an internal volume of cavity 226 is the product of thickness t and an area of cavity 226. Like exemplary piston arrangement 10 shown in FIG. 5, a volume adjuster (e.g., exemplary volume adjuster 86 shown in FIG. 5) may be incorporated into any member 212, 214, 216, and 218 of exemplary piston arrangement 210 (or any opposing plate, e.g., first and second plates 100 and 90) as desired in order to vary the internal volume of cavity 226 so that exemplary piston arrangement 210 may be tuned for a specific application without need to change the dimensions of any of members 212, 214, 216, 218 and while maintaining a constant thickness t.

Although not shown in FIGS. 7-10, exemplary piston arrangement 210 may comprise each of the components described above with regard to exemplary piston arrangement 10 (e.g., a fuel injector conduit, an exhaust remover conduit, and a volume adjuster, a first plate, and a second plate).

B. Strokes of a Four Member Piston Arrangement

FIGS. 7-10 illustrate various configurations of exemplary piston arrangement 210 at various times throughout a given combustion cycle. A description of various strokes within a given cycle is provided below.

1. Intake Stroke

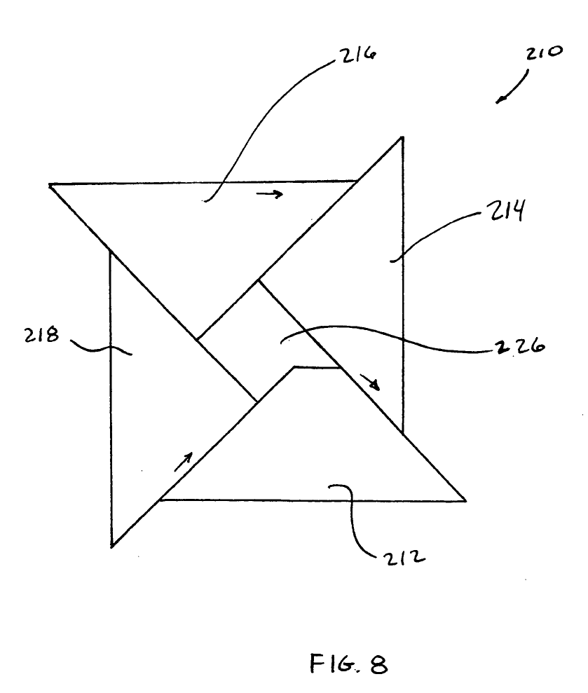

FIG. 7 illustrates a first position in which a size of cavity 226 is relatively small such as may be desired prior to injecting fuel into cavity 226. In the transition from the configuration shown in FIG. 7 to the configuration shown in FIG. 8, first movable member 214, second movable member 216, and third movable member 218 move from a first position to a second position in directions as indicated by arrows F₁, F₂ and F₃ in FIG. 7. In moving from the configuration of FIG. 7 to the configuration of FIG. 8, fuel may be injected into cavity 226 by a fuel injector (e.g., a fuel injector similar to exemplary fuel injector 80 as discussed above and as shown in FIG. 5).

FIG. 8 illustrates an exemplary maximum intake configuration for cavity 226 based on the positioning of first, second and third movable members 214, 216, and 218 relative to stationary member 212. The transition from the configuration of FIG. 7 to the configuration of FIG. 8 may be termed the “intake stroke.”

2. Compression Stroke

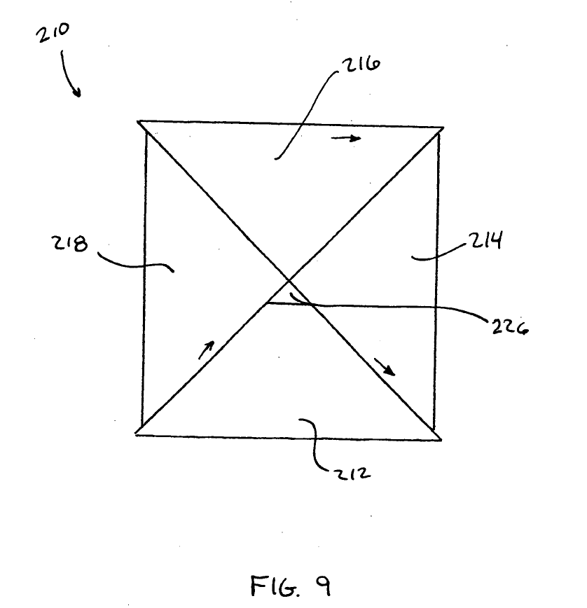

In the transition from the configuration shown in FIG. 8 to the configuration shown in FIG. 9, the size of cavity 226 is reduced, thus compressing fuel within cavity 226. This transition may be termed the “compression stroke.”

At the end of the compression stroke, fuel within cavity 226 may be ignited. As discussed above, the actual positioning of first, second and third movable members 214, 216, and 218 relative to stationary member 212 at the ignition point may vary (e.g., at some point when cavity 226 is of a minimum size (see, for example, FIG. 9) or some point other than when cavity 226 is of a minimum size (e.g., immediately prior to or after reaching a minimum size of cavity 226)).

3. Combustion Stroke

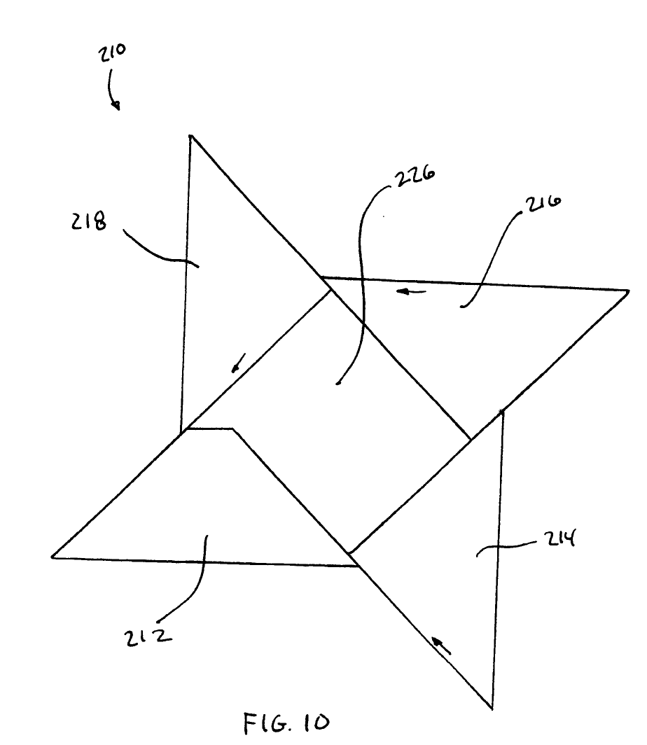

As the fuel is combusted in cavity 226, exemplary piston arrangement 210 transitions from the configuration shown in FIG. 9 to the configuration shown in FIG. 10. This transition may be termed the “combustion stroke.”

4. Exhaust Stroke

FIG. 10 is illustrative of exemplary piston arrangement 210 in which fuel within cavity 226 has been ignited and burned and is ready to be exhausted from cavity 226. In transitioning from the configuration shown in FIG. 10 to the configuration shown in FIG. 7, the spent fuel may be exhausted out of cavity 226 by way of an exhaust remover (see, for example, exhaust remover 84 shown in FIG. 5). This transition may be termed the “exhaust stroke.”

At this point, the cycle shown in FIGS. 7-10 may be repeated as desired.

### III. Exemplary Materials For Piston Arrangements

The exemplary piston arrangement components described above may be constructed from various materials. In one exemplary embodiment, hardened aluminum is satisfactory for constructing the various plates, stationary and movable members. In another embodiment, stainless steel may be used for the various plates, stationary and movable members. Other suitable materials for forming plates, stationary members, and movable members of the exemplary piston arrangements disclosed above include, but are not limited to, plastics, steel, metal alloys, composite materials (e.g., fiber reinforced plastics), ceramics, carbon matrix material, carbon fibers, and other fibers (e.g., metal fibers, ceramic fibers, etc.). The various plates, stationary and movable members may be prepared by milling, then cutting, bending, and welding as necessary.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A piston arrangement comprising:
at least one stationary member;
first and second movable members; and
a fuel-ignition cavity formed between one or more outer surfaces of said at least one stationary member and one or more outer surfaces of each of said first and second movable members;
wherein a size of said fuel-ignition cavity changes as said first and second movable members move along outer surfaces of said at least one stationary member.

2. The piston arrangement of claim 1, further comprising:
opposing first and second plates positioned along opposing outer surfaces of said at least one stationary member and said first and second movable members, said fuel-ignition cavity being further bound by opposing outer surfaces of said first and second plates.

3. The piston arrangement of claim 2, wherein said first and second movable members are movable along outer surfaces of said at least one stationary member between said opposing outer surfaces of said first and second plates.

4. The piston arrangement of claim 1, further comprising:
a third movable member positioned so as to contact outer surfaces of said first and second movable members; wherein said cavity is formed between one or more outer surfaces of said at least one stationary member and one or more outer surfaces of each of said first, second and third movable members.

5. The piston arrangement of claim 1, further comprising a fuel injector capable of injecting fuel into said fuel-ignition cavity.

6. The piston arrangement of claim 1, further comprising an exhaust remover capable of removing combustion products from said fuel-ignition cavity.

7. The piston arrangement of claim 1, further comprising a biaser in contact with said second movable member, said biaser being operatively adapted so as to force said second movable member into contact with said first movable member.

8. The piston arrangement of claim 1, further comprising a linkage connecting said first movable member to a crankshaft.

9. The piston arrangement of claim 8, wherein movement of said first movable member along an outer surface of said at least one stationary member causes the crankshaft to rotate via said linkage.

10. The piston arrangement of claim 1, further comprising:
opposing first and second plates positioned along opposing outer surfaces of said at least one stationary member and said first and second movable members, said fuel-ignition cavity being further bound by opposing outer surfaces of said first and second plates;
a fuel injector capable of injecting fuel into said fuel-ignition cavity;
an exhaust remover capable of removing combustion products from said fuel-ignition cavity;
a biaser in contact with said second movable member, said biaser being operatively adapted so as to force said second movable member into contact with said first movable member; and
a linkage connecting said first movable member to a crankshaft.

11. The piston arrangement of claim 10, further comprising:
a third movable member positioned so as to contact outer surfaces of said first and second movable members; wherein said cavity is formed between one or more outer surfaces of said at least one stationary member and one or more outer surfaces of each of said first, second and third movable members.

12. An internal combustion engine comprising the piston arrangement of claim 1.

13. An internal combustion engine comprising the piston arrangement of claim 10.

14. An internal combustion engine comprising:
a crankshaft housing,
a crankshaft located within said crankshaft housing, and
a piston arrangement comprising:
at least one stationary member;
first and second movable members;
opposing first and second plates positioned along opposing outer surfaces of said at least one stationary member and said first and second movable members; and
a fuel-ignition cavity formed between one or more outer surfaces of said at least one stationary member, one or more outer surfaces of each of said first and second movable members, and opposing outer surfaces of said first and second plates;
wherein a size of said fuel-ignition cavity changes as said first and second movable members move along outer surfaces of said at least one stationary member between said opposing outer surfaces of said first and second plates; and
wherein said crankshaft is linked to said first movable member such that as said first movable member moves along an outer surface of said at least one stationary member, said crankshaft rotates.

15. The internal combustion engine of claim 14, wherein said piston arrangement further comprises:
a third movable member positioned between opposing outer surfaces of said first and second plates and along and in contact with outer surfaces of said first and second movable members; wherein said cavity is formed between one or more outer surfaces of said at least one stationary member, one or more outer surfaces of each of said first, second and third movable members, and opposing outer surfaces of said first and second plates.

16. The internal combustion engine of claim 14, further comprising a fuel injector capable of injecting fuel into said fuel-ignition cavity.

17. The internal combustion engine of claim 14, further comprising an exhaust remover capable of removing combustion products from said fuel-ignition cavity.

18. The internal combustion engine of claim 14, further comprising a biaser in contact with said second movable member, said biaser being operatively adapted so as to force said second movable member into contact with said first movable member.

19. The internal combustion engine of claim 14, further comprising a biaser in contact with said second movable member, said biaser being operatively adapted so as to force said second movable member into contact with said first movable member.

20. A method of generating power in internal combustion engine; said method comprising:
introducing fuel into a fuel-ignition cavity of a piston arrangement, the piston arrangement comprising:
at least one stationary member;
first and second movable members;
opposing first and second plates positioned along opposing outer surfaces of the at least one stationary member and the first and second movable members;
wherein the fuel-ignition cavity is formed between one or more outer surfaces of the at least one stationary member, one or more outer surfaces of each of the first and second movable members, and opposing outer surfaces of the first and second plates;
moving the first and second movable members along outer surfaces of the at least one stationary member between the opposing outer surfaces of the first and second plates so as to compress the fuel;
igniting the fuel;
allowing the first and second movable members to move along outer surfaces of the at least one stationary member between the opposing outer surfaces of the first and second plates in response to said igniting of the fuel; and
linking the first movable member to a crankshaft such that movement of the first movable member along an outer surface of the at least one stationary member causes the crankshaft to rotate so as to generate power.
